(19) United States
(12) Patent Application Publication
(10) Pub. No.: US 2002/0109051 A1
(43) Pub. Date: Aug. 15, 2002

(54) Computer keyboard stand

(76) Inventors: Hiroaki Kitagawa, Tokyo (JP); Chiyoko Kitagawa, Tokyo (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/025,552

(22) Filed: Dec. 26, 2001

(30) Foreign Application Priority Data
Jan. 11, 2001 (JP) 2001-003438
Apr. 3, 2001 (JP) 2001-104240
Jul. 4, 2001 (JP) 2001-203430

(51) Int. Cl. F16M 11/00; A45D 19/04; A47J 47/16

(52) U.S. Cl. 248/127

(57) ABSTRACT

The computer keyboard stand is a set of lightweight simple device attachable to the back ridge of the keyboard. The keyboard stand can hold the keyboard in an upright position when it is not in use. This invention provides another posture of the keyboard when it is not in use. By having the keyboard take this posture, the keyboard occupies less area on the desk. Also, the back of the keyboard can be used as a miniature billboard. The upright posture can also be used as a sign to indicating that the computer user is not in his/her office at the moment.

### BACKGROUND OF THE INVENTION

1. Field of the Invention

This invention relates to a keyboard stand attached on a keyboard body, which enables the keyboard to hold in an upright position. The keyboard stand also provides new ways of treating a computer keyboard when it is not in use.

2. Description of the Related Art

Computer keyboards conventionally have been usually kept on the desks in the same operational position with the front face up even when they are not in use. There have been some earlier attempts to keep the computer keyboard in an upright position to save desk area with a single holder into which the keyboard is to be inserted. Such a holder, however, was nothing but another additional bulky item and was not designed to become a part of the keyboard. Therefore, they have not been accepted by many people. Also, they did not provide any other positive ways of the keyboard usage.

### SUMMARY OF THE INVENTION

It is therefore an object of the present invention to provide a keyboard stand of small size and lightweight.

Another object is to provide new ways of treating a computer keyboard when it is in not in use.

According to the present invention, the computer keyboard is supported by an item which is not bulky to support the upright position of the keyboard.

The keyboard stand is attached on at the back ridge of the computer keyboard. In this way, the total amount of the material used for this supporter can be substantially reduced. Also, production cost can be significantly reduced.

This invention can typically include two small pieces. Each piece is so designed that it can grasp a portion of the computer keyboard's back ridge area, sandwiching the thickness of the ridge with its two arms. The distance between the lower arm and the upper arm can be adjusted so that the keyboard stand can be applied to various types of keyboards. The keyboard stand should clasp the keyboard tightly enough so as not to allow any wobbling of the keyboard between the two arms.

When the keyboard is in use, the two lower arms of the keyboard stand function as a tilting pillow that makes a slight angle for the keyboard so that the computer user can type easily.

When the computer user finishes his/her work, then she can lift up both ends of the front ridge of the keyboard and turn it around 90 degrees upward such that the back of the keyboard face to her. The keyboard stand functions as feet for the computer keyboard to stand up on the desk. With secure and stable upright position of the keyboard, the back face of the keyboard can be used as an ornamental item. It can be used for the purpose of holding photos or pictures. It is preferable for the back face to define an angle of 70-80 degrees with the desk surface. The keyboard stand can be designed to achieve this angle.

### BRIEF DESCRIPTION OF THE DRAWINGS

FIG. 1 shows a perspective view of the computer keyboard in use with the invented stand attached to the back ridge of it.

FIG. 2 shows a perspective view of the computer keyboard not in use with the invented stand attached to it.

FIG. 3 shows a side view of FIG. 1 indicating the role of the lower arm clearly.

FIG. 4 shows a side view of FIG. 2 indicating that the narrower angle of the back face of the keyboard to the face of the desk is around 75 degrees, which provides a secured standing position and an easier-to-see face angle for the back of the keyboard.

FIG. 5 is a partial view of an example of how the stand grasps the portion of the back ridge of the keyboard. The grasp has to be tight enough to securely hold the keyboard.

FIG. 6 is a partial view of the second example of how the stand grasps the portion of the back ridge of the keyboard.

FIG. 7 is a partial view of the third example of how the stand grasps the portion of the back ridge of the keyboard.

FIG. 8 is a partial view of the fourth example of how the stand grasps the portion of the back ridge of the keyboard.

### DESCRIPTI0N OF THE PREFERRED EMBODIMENTS

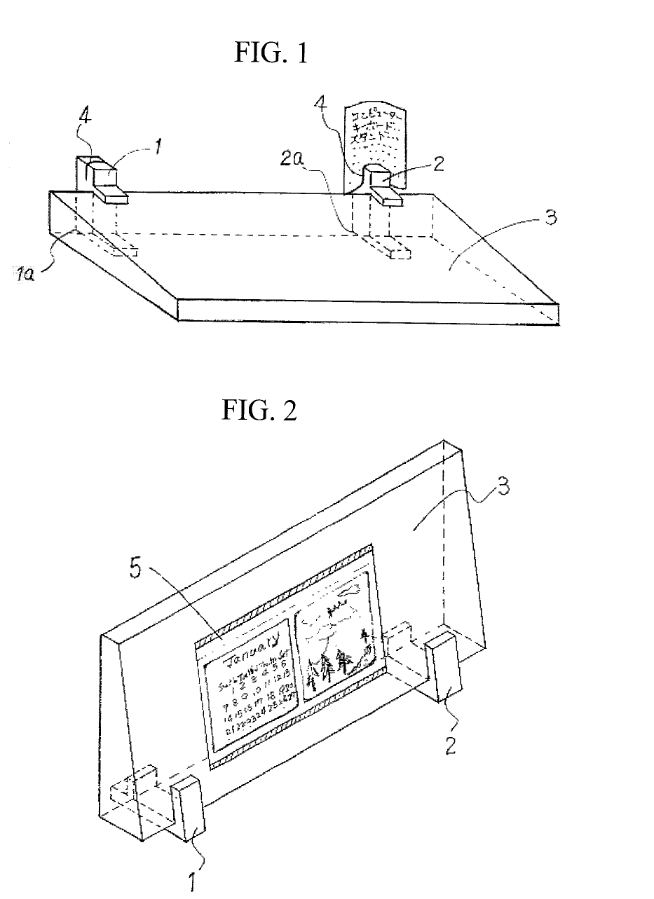

FIG. 1 shows the computer keyboard in use with the keyboard stand attached to the back ridge of it. The keyboard stand can include two units separately attached to the keyboard. Each unit of the keyboard stand can be separately attached to the back ridge of the computer keyboard. The lower arm of the stand serves as a tilting pillow making an appropriate angle for the keyboard front so that the computer user could type easily. The arm portions should be of the same thickness between units so as to function as a tilting stand when the keyboard is in use. The right-hand piece of the stand has a slit 4 to hold a leaf of paper.

FIG. 2 shows the computer keyboard, with the keyboard stand of the present invention attached to it, in its upright position when the keyboard is not in use. This upright position provides the user with wider desk space.

The base portion of the stand can have any shape which stably sustains the upright position of the keyboard when the keyboard is in upright position.

Conventionally, the backside surface of the keyboard had never been considered to be useful for any specific purposes. The present invention provides a new use to the backside surface of the keyboard by attaching a holder, such as a pocket, which holds a picture, a mini-calendar, etc. It is preferable for the backside surface of the keyboard to have a smooth surface so as to be used as a miniature board for photos, various cards, brief notes, plans, and small calendars etc.

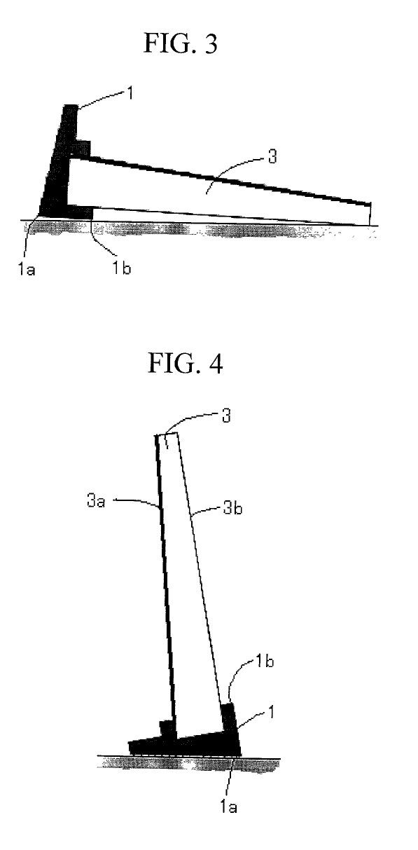

FIG. 1 and FIG. 3 show the way how this keyboard stand 1 and 2 works when the keyboard 3 is in use. The keyboard 3 is slightly tilted with the help of the lower arm's thickness. Either pieces of the stand may have a slit 4 to hold a paper piece for user's convenience. When the computer user wants to stand up the keyboard, she can do so just by lifting up the front ridge of the keyboard with her hands. The point 1a in FIG. 1 and FIG. 3 works as a pivoting point when the front ridge is lifted up.

The keyboard can stand, as shown in FIG. 2 and FIG. 4, with the backside surface of the keyboard facing toward the user. The backside surface of the keyboard can be used to put up photos, pictures, cards, calendars etc. for the user fun, convenience or commemoration. In FIG. 2 the backside surface of the keyboard has a pocket 5 for a picture and a calendar. In order to have the angled backside surface 1, as shown in FIG. 4, the stand's corner 1a should have an inclined angle of, for example, 75 degrees. The upright position of the keyboard can also used as a sign to tell that the computer user is not in her office at the moment.

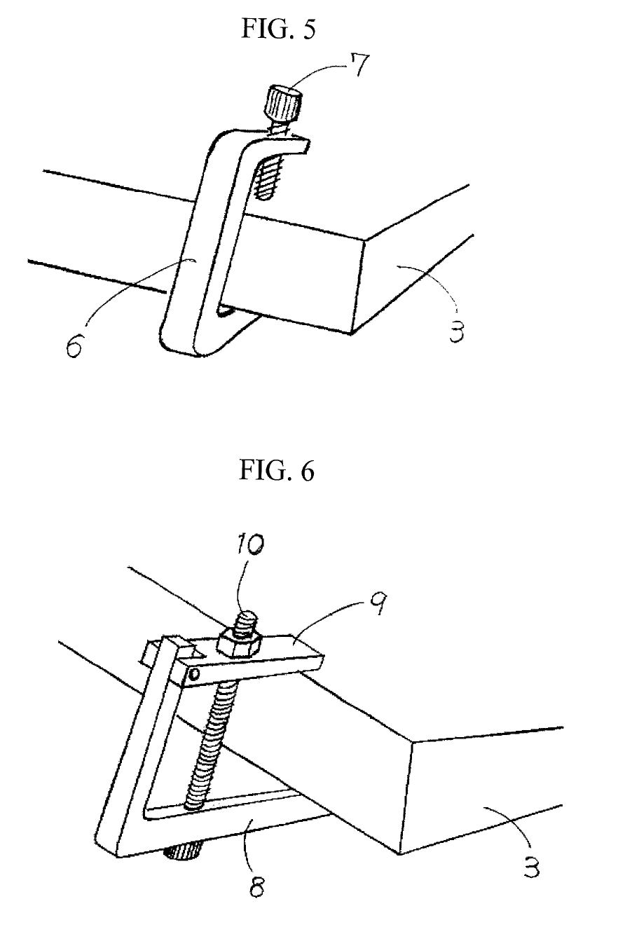

This keyboard stand of the present invention has to be kept attached tightly to the back ridge of the keyboard because the user may flip and flop the keyboard as many times and with as much speed as she wishes. FIG. 5 is an example to securely hold the back ridge of the keyboard 3 with a bolt 7 threaded into the upper arm of the stand 6. By rotating the screw bolt 7, the stand clasps the thickness of the back ridge of the keyboard. This way of holding the keyboard is applicable to any different size of keyboard.

In FIG. 6, the keyboard stand has a stem having a lower arm 8, and an upper arm 9 connected to the upper end of the stem with a pin, and fixing member 10, such as a bolt and nut. By fastening the bolt and nut 10, the upper arm and the lower arm can grasp the back ridge portion of the keyboard. This type also is applicable to all different sizes of keyboards.

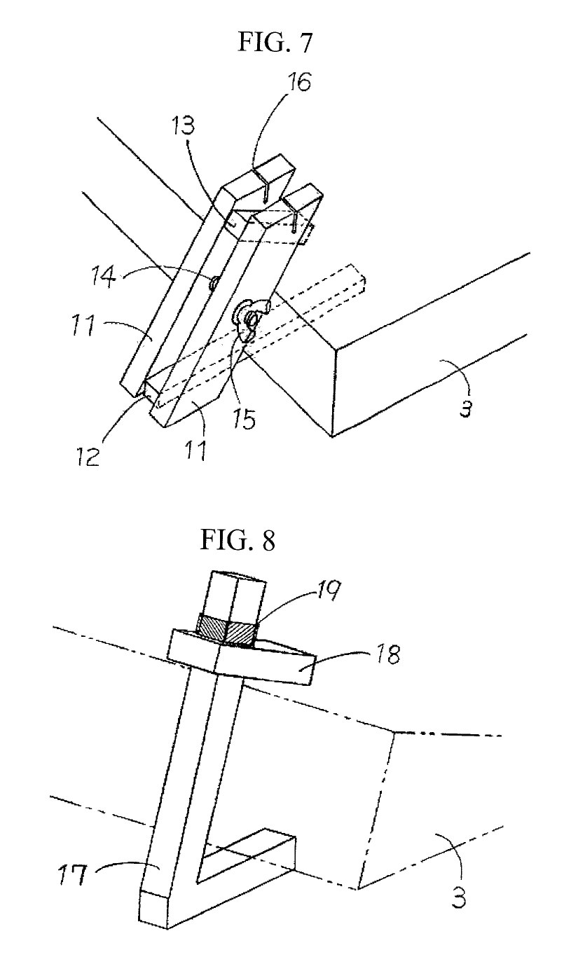

In FIG. 7, two side plates 11 sandwich the lower arm 12 and the upper arm 13 with the help of tightening force by such as a bolt 14 and a butterfly nut 15 in a position that the two arms grasp the keyboard's back ridge portion.

FIG. 8 is an example of how to grasp the back ridge of the keyboard without using bolt and nut. The upper arm 18 has a hole through which a stem of the member 17 extends. The upper arm 18 stays in the fixed position with the help of the stopper 19, which is a tube made of elastic material such as silicon-rubber, which holds the stem's face tightly enough to serve as a stopper, and can be moved to another position along the stem easily enough with fingers of the user for adjusting purpose. In this way, two separate parts of the keyboard's back ridge can be held between the upper and the lower arm. This type of stand is also applicable to every size of keyboard.

What is claimed is:

1. A keyboard stand comprising:
a base portion; and
a pair of arm portions extending from the base portion, the arm portions capable of securely holding a body of a keyboard,
wherein the keyboard stand enabling the keyboard to stand in an upright position.

2. The keyboard stand according to claim 1, further comprising a means for adjusting a space between the pair of arm portions.

3. The keyboard stand according to claim 1, wherein the keyboard stand comprises a plurality of separate units.

4. The keyboard stand according to claim 1, further comprising a slit for holding pieces of paper.

5. A keyboard comprising:
a base portion at a back ridge portion, the base portion having an area sufficient to enable the keyboard to stably stand in an upright position.

6. The keyboard according to claim 5, wherein the base portion is integrally formed.
